(19) United States
(12) Patent Application Publication
(10) Pub. No.: US 2026/0237762 A1
(43) Pub. Date: Aug. 13, 2026

(54) BATTERY CELL SENSING ASSEMBLY FOR A BUSBAR INTERCONNECT FOR A BATTERY PACK

(71) Applicant: TE Connectivity Solutions GmbH, Schaffhausen (CH)

(72) Inventor: Evan DAWLEY, Troy, MI (US)

(21) Appl. No.: 19/410,399

(22) Filed: Dec. 5, 2025

Related U.S. Application Data
(60) Provisional application No. 63/757,648, filed on Feb. 12, 2025.

(51) Int. Cl. H01M 10/42; H01M 50/507

(52) U.S. Cl. CPC H01M 10/425; H01M 50/507; H01M 2010/4271

(57) ABSTRACT

A battery cell sensing assembly for monitoring cell terminals of battery cells in a battery pack includes a cell sensing flexible circuit having a repeating trace pattern along a length of the cell sensing flexible circuit. The trace pattern includes a first and second cell pads for connection to a first and second cell terminals of the battery cell and a first and second sensor pads coupled to the cell pads by first and second conductors. The battery cell sensing assembly includes BMS sensor assemblies coupled to the cell sensing flexible circuit each coupled to the corresponding trace pattern. The BMS sensor assembly includes a sensor PCB, an integrated circuit mounted to the sensor PCB, and a sensor antenna operably coupled to the integrated circuit. Each BMS sensor assembly is configured to be operably coupled to and monitor a different battery cell of the battery pack.

### CROSS REFERENCE TO RELATED APPLICATIONS

This application claims priority to U.S. Application No. 63/757,648, filed 12 Feb. 2025, subject matter of which is herein incorporated by reference in its entirety.

### BACKGROUND OF THE INVENTION

The subject matter herein relates generally to battery packs, such as battery packs for electric vehicles.

Electric vehicles include a battery system including a battery pack having a large number of battery cells. A typical battery system requires a connectivity solution to transfer/distribute power between groups of battery cells and have provisions for sensing battery parameters like voltage and temperature. To transfer power, busbars (aluminum or copper) are usually welded to the cell terminals in serial and/or parallel electrical configuration. As electric vehicle applications proliferate, the overhead cost of components ($/kWh) is scrutinized and there is a desire to minimize costs, such as by minimizing the part count and part numbers. For battery systems of electric vehicles, the battery cell stack sizes are very large. Typically, assembly of the battery system requires many parts, which are individually assembled to the corresponding cell terminals, which is time consuming and adds cost to the assembly process. For example, individual busbars may be separately assembled and welded to the corresponding cell terminals, which is time consuming and increases the cost of assembly.

Conventional battery systems incorporate a battery management system for monitoring the battery cells. The battery management system typically includes a sensor harness having many sensors and corresponding wires that are individually terminated to the busbars to monitor the battery cells, such as to monitor voltage, temperature, and the like. However, conventional battery management system have processors that manage signals from many sensors and are susceptible to errors associated with the long lengths of traces between the sensors and the processor. The traces have high resistance due to the long lengths and are more expensive because the conductors are thick to accommodate the long length between the sensor and the processor.

A need remains for a method for assembling battery packs, such as for electric vehicles, in a cost effective and reliable manner.

### BRIEF DESCRIPTION OF THE INVENTION

In an embodiment, a battery cell sensing assembly for monitoring cell terminals of battery cells in a battery pack is provided. The battery cell sensing assembly includes a cell sensing flexible circuit having a repeating trace pattern along a length of the cell sensing flexible circuit. The trace pattern includes a first cell pad for connection to a first cell terminal of the battery cell and a second cell pad for connection to a second cell terminal of the battery cell. The trace pattern includes a first sensor pad coupled to the first cell pad by a first conductor and a second sensor pad coupled to the second cell pad by a second conductor. The battery cell sensing assembly includes battery management system (BMS) sensor assemblies coupled to the cell sensing flexible circuit. Each BMS sensor assembly coupled to the corresponding trace pattern. The BMS sensor assembly includes a sensor printed circuit board (PCB), an integrated circuit mounted to the sensor PCB, and a sensor antenna operably coupled to the integrated circuit. The sensor PCB coupled to the first and second sensor pads to receive signals from the first and second cell terminals. The integrated circuit operably coupled to the battery cell through the sensor PCB. The integrated circuit monitoring at least one operating characteristic of the battery cell. The sensor antenna configured to transmit a sensor signal from the BMS sensor assembly relating to the at least one operating characteristic. Each BMS sensor assembly is configured to be operably coupled to and monitor a different battery cell of the battery pack.

In a further embodiment, a busbar interconnect for electrically connecting cell terminals of battery cells in a battery pack is provided. The busbar interconnect includes a cell bussing web extending between a first side and a second side. The cell bussing web includes a plurality of busbars arranged in a matrix having one or more rows of the busbars and one or more columns of the busbars. Each busbar includes a first mating end for mating with the corresponding cell terminal of the corresponding battery cell and a second mating end for mating with the adjacent cell terminal of the adjacent corresponding battery cell. The busbars are configured to electrically connect the battery cells in the battery pack. The busbar interconnect includes an insulation film covering the busbars. The insulation film includes windows exposing portions of the busbars. The busbar interconnect includes a battery cell sensing assembly coupled to the cell bussing web. The battery cell sensing assembly includes a cell sensing flexible circuit and battery management system (BMS) sensor assemblies coupled to the cell sensing flexible circuit. The cell sensing flexible circuit has a repeating trace pattern along a length of the cell sensing flexible circuit. The trace pattern includes a first cell pad for connection to a first busbar of the plurality of busbars at the first side of the cell bussing web and a second cell pad for connection to a second busbar of the plurality of busbars at the second side of the cell bussing web. The trace pattern includes a first sensor pad coupled to the first cell pad by a first conductor and a second sensor pad coupled to the second cell pad by a second conductor. Each BMS sensor assembly coupled to the corresponding trace pattern. The BMS sensor assembly includes a sensor printed circuit board (PCB), an integrated circuit mounted to the sensor PCB, and a sensor antenna operably coupled to the integrated circuit. The sensor PCB coupled to the first and second sensor pads to receive signals from the first and second cell terminals. The integrated circuit operably coupled to the battery cell through the sensor PCB. The integrated circuit monitoring at least one operating characteristic of the battery cell. The sensor antenna configured to transmit a sensor signal from the BMS sensor assembly relating to the at least one operating characteristic. Each BMS sensor assembly is configured to be operably coupled to and monitor a different battery cell of the battery pack.

### BRIEF DESCRIPTION OF THE DRAWINGS

FIG. 1 is a perspective view of a battery pack including a battery pack interconnect assembly in accordance with an exemplary embodiment.

FIG. 2 is a top view of the battery pack interconnect assembly in accordance with an exemplary embodiment.

FIG. 3 illustrates a stack of the battery cells in accordance with an exemplary embodiment.

FIG. 4 illustrates a cell bussing web for connecting to the stack of battery cells shown in FIG. 3 in accordance with an exemplary embodiment.

FIG. 5 illustrates the cell bussing web in accordance with an exemplary embodiment.

FIG. 6 is an enlarged view of a portion of the cell bussing web shown in FIG. 5 in accordance with an exemplary embodiment.

FIG. 7 illustrates the cell bussing web in accordance with an exemplary embodiment showing a conductive adhesive film applied to the metal sheet.

FIG. 8 illustrates the cell bussing web in accordance with an exemplary embodiment showing the insulation film surrounding the metal sheet.

FIG. 9 illustrates the cell bussing web in accordance with an exemplary embodiment showing the insulation film and the metal sheet after removal of the sacrificial connecting tabs.

FIG. 10 illustrates the cell sensing flexible circuit in accordance with an exemplary embodiment.

FIG. 11 illustrates the cell sensing flexible circuit with the BMS sensor assemblies coupled to the cell sensing flexible circuit in accordance with an exemplary embodiment.

FIG. 12 is a top view of the BMS sensor assembly in accordance with an exemplary embodiment.

FIG. 13 is a bottom view of the BMS sensor assembly in accordance with an exemplary embodiment.

FIG. 14 illustrates the cell bussing web in accordance with an exemplary embodiment showing the cell sensing flexible circuit coupled to the insulation film and the busbars.

FIG. 15 is a cross-sectional view of the cell bussing web showing the cell sensing flexible circuit and the BMS sensor assembly coupled to the cell bussing web in accordance with an exemplary embodiment.

FIG. 16 illustrates a manufacture process for the cell bussing web in accordance with an exemplary embodiment.

### DETAILED DESCRIPTION OF THE INVENTION

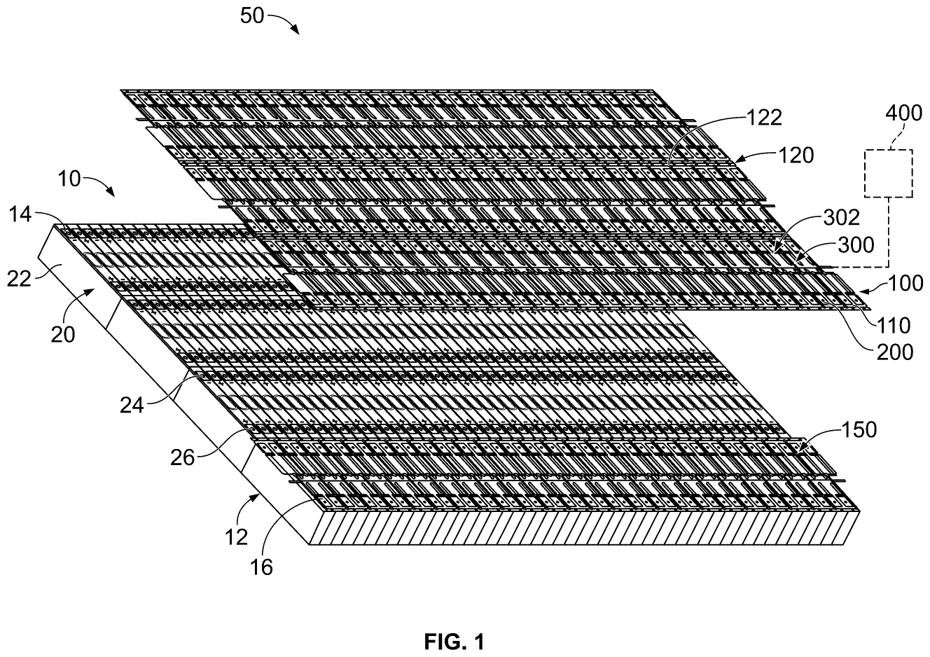

FIG. 1 is a perspective view of a battery pack 10 including a battery pack interconnect assembly 50 in accordance with an exemplary embodiment. The battery pack interconnect assembly 50 includes a busbar interconnect 100 having one or more cell bussing webs 150 for electrically connecting to the battery pack 10. The busbar interconnect 100 includes a plurality of busbars 200 and a battery cell sensing assembly 300 for sensing parameters of the battery pack, such as voltage, temperature, charge state, or other operating characteristics of the battery pack 10. The battery cell sensing assembly 300 is coupled to the cell bussing web 150. Each cell bussing web 150 includes a plurality of the busbars 200 arranged in one or more rows and one or more columns.

The battery pack 10 may be a battery pack for a vehicle, such as an electric vehicle. However, the battery pack 10 may be used in other applications in alternative embodiments. In an exemplary embodiment, the battery pack 10 is a high voltage battery pack. For example, the battery pack 10 may be a 400V or 800V battery pack. The busbar interconnect 100 is used to electrically connect a matrix of battery cells 20 of the battery pack 10. For example, the busbar interconnect 100 may electrically connect the battery cells 20 in series and/or parallel.

The battery cells 20 may be held in a battery pack housing 12. The battery pack 10 includes a positive battery interconnect terminal 14 and a negative battery interconnect terminal 16. The battery interconnect terminals 14, 16 may interface to other power distribution components of the battery pack 10, such as contactors and fuses for connection to a charging system and/or a load, such as an electric motor.

Each battery cell 20 includes a cell housing 22, a first cell terminal 24, and a second cell terminal 26. The battery cell 20 may be a prismatic battery cell in various embodiments. The first and second cell terminals 24, 26 may be cathode and anode terminals. In an exemplary embodiment, the battery cell 20 are rectangular and arranged in a stacked configuration. For example, the battery cells 20 may be stacked in rows and columns of battery cells 20 in the matrix. In an exemplary embodiment, each cell bussing web 150 may be coupled to a respective row or column of the stack of battery cells 20. The cell bussing webs 150 may be arranged side by side with associated rows or columns of the stacks of battery cells 20. In other various embodiments, each cell bussing web 150 may be associated with multiple rows or columns of the stacks of the battery cells 20. The cell matrix may have a large surface area, such as greater than two square meters (2 m² or more). For example, the matrix may have a length of between approximately 1.0 m and 2.0 m and a width of between approximately 1.0 m and 1.5 m. Adjacent battery cells 20 in the rows are interconnected by the corresponding busbars 200 of the busbar interconnect 100. Adjacent rows of the battery cells 20 are interconnected by the corresponding busbars 200 of the busbar interconnect 100. For example, end battery cells 20 may be connected row-to-row.

The busbar interconnect 100 includes a busbar carrier 110 holding the cell bussing web(s) 150 and the associated busbars 200. The busbar carrier 110 holds the cell bussing webs 150 and the busbars 200 at relative locations for mating with the cell terminals 24, 26 of the corresponding battery cells 20. The busbars 200 electrically connect adjacent battery cells 20, such as in series and/or in parallel. In various embodiments, the busbar carrier 110 integrates all of the cell bussing webs 150 and the busbars 200 into a single unit or structure for mounting to the matrix of battery cells 20. For example, a single busbar carrier 110 may be used to hold all of the busbars 200. In other various embodiments, the busbar carrier 110 may include multiple frames or units, each holding a plurality of the busbars 200, such as a column of the busbars 200, the frames/units may be connected together by other elements of the busbar carrier 110 to form a connected structure. For example, each cell bussing web 150 may have an associated busbar carrier 110 and the busbar carriers 110 may be coupled together to position the cell bussing webs 150 over the corresponding stacks of the battery cells 20.

In various embodiments, the busbar carrier 110 may be a molded plastic structure, a structural foam leadframe, a laminated film, or other structural component configured to hold the busbars 200. The busbar carrier 110 may be formed in place over the cell bussing web 150 and the corresponding busbars 200. For example, the busbar carrier 110 may be molded or formed on the cell bussing web 150. For example, the busbar carrier 110 may be overmolded in situ over portions of the busbars 200 to form the busbar interconnect 100. In other embodiments, the busbar carrier 110 is laminated over the cell bussing web 150. The busbar carrier 110 may be applied to the cell bussing web 150, such as being adhered to the cell bussing web 150. The busbar carrier 110 may be formed around portions of the cell bussing web 150 to hold the busbars 200 relative to each other and relative to the cell terminals 24, 26 of the battery cells 20.

In an exemplary embodiment, the busbar carrier 110 may include a framework or lattice 120 formed around portions of the busbars 200 to hold the busbars 200 at relative positions. In an exemplary embodiment, the busbar carrier 110 holds all of the busbars 200 of each cell bussing web 150 and/or for the battery pack 10 to reduce part count for final assembly to the battery pack 10. For example, a single busbar interconnect 100 may be assembled to the battery pack 10. The busbar carrier 110 is used to position the busbars 200 for electrical connection to the cell terminals 24, 26 of the battery cells 20. In an exemplary embodiment, the battery cell sensing assembly 300 is coupled to the busbar carrier 110. The busbar carrier 110 may be used to position the sensing harness on the battery cells 20.

In an exemplary embodiment, the battery cell sensing assembly 300 has sensing points 302 for monitoring the busbars 200 and/or the cell terminals 24, 26. For example, the battery cell sensing assembly 300 is electrically connected to the busbars 200 at the sensing points 302 to monitor voltage, temperature, charge state, or other operating characteristics of the busbars 200 and/or the cell terminals 24, 26. The battery cell sensing assembly 300 is configured to be electrically connected to a control module 400, such as a battery control module. The battery cell sensing assembly 300 sends sensing signals from the sensing points 302 to the control module 400, which may be used to control operation of the vehicle and/or a charging operation of the vehicle. In an exemplary embodiment, the battery cell sensing assembly 300 includes flexible circuits, such as flat flexible cables or flexible printed circuits, associated with the corresponding cell bussing webs 150. For example, the flexible circuits may be applied to or integrated with the cell bussing webs 150 during assembly and manufacture of the busbar interconnect 100.

The battery pack interconnect assembly 50 provides a large format battery cell interconnect assembly that is configured to be mounted to the battery pack 10 (for example, each of the battery cells 20) as a single unit. The busbar carrier 110 holds the busbars 200 at proper locations for termination to the cell terminals 24, 26 of each of the battery cells 20 of the battery pack 10. By holding all of the busbars 200 of the cell bussing web(s) 150 for assembly to the corresponding battery cells 20, assembly processes may be eliminated, such as with conventional battery systems where each of the busbars are assembled to the battery cells individually with multiple assembly steps. The busbar interconnect 100 reduces the overall part number count and reduces the number of handled components during assembly of the battery pack 10. The busbar carrier 110 may have a large format and surface area. For example, the structural process to manufacture the lattice framework for the busbar carrier 110 enables a large footprint for the busbar carrier 110. The structural material of the lattice framework for the busbar carrier 110 is dimensionally stable and does not tend to warp making assembly and termination to the battery cells more simple, quicker, and lower cost compared to conventional assembly processes.

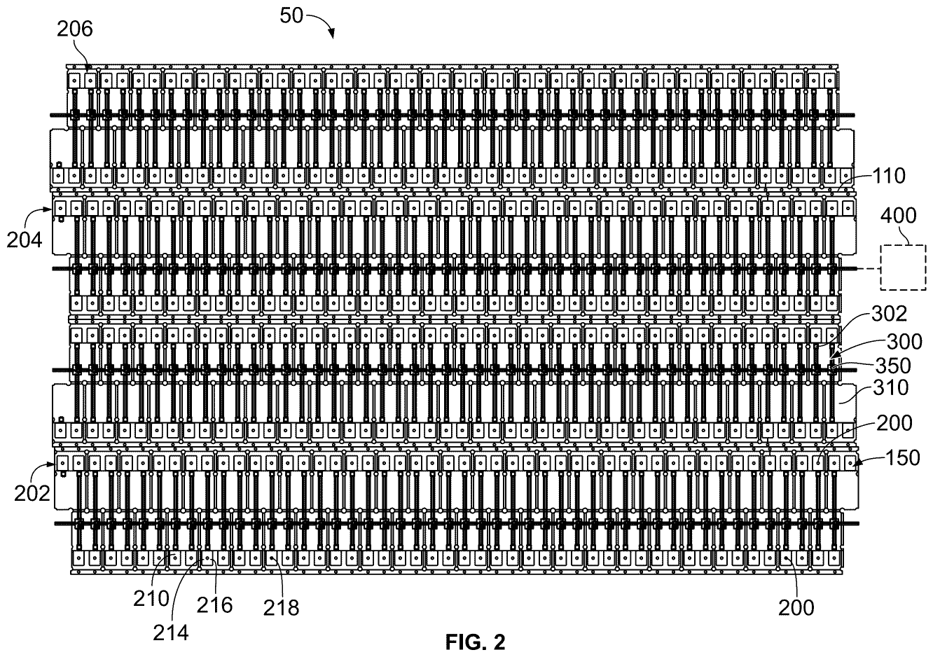

FIG. 2 is a top view of the battery pack interconnect assembly 50 in accordance with an exemplary embodiment. FIG. 2 illustrates the cell bussing webs 150 forming a matrix 202 of the busbars 200 and the battery cell sensing assembly 300 coupled to the busbars 200. The busbars 200 are arranged in rows 204 and columns 206 in the matrix 202. In an exemplary embodiment, each cell bussing web 150 forms one or more strips of the busbars 200, such as one or more of the columns 206 of the busbars 200. Each cell bussing web 150 may include multiple rows of the busbars 200.

The arrangement of the busbars 200 corresponds to the arrangement of the battery cells 20 to connect to the corresponding cell terminals 24, 26. The battery cell sensing assembly 300 traverses the rows 204 and columns 206 of the busbars 200 to electrically connect to the corresponding busbars 200 for sensing characteristics (for example, voltages) of each of the busbars 200.

Each busbar 200 includes a metal plate 210 having a main body including a first mating pad 214 at a first end and a second mating pad 216 at a second end. The first mating pad 214 is configured to connect to a cell terminal 24 of one of the battery cells 20. The second mating pad 216 is configured to connect to a cell terminal 26 of an adjacent battery cell 20. The busbar 200 electrically connects the adjacent battery cells 20. The mating pads 214, 216 may include openings 218 therethrough, such as for locating the busbars 200 relative to the cell terminals 24, 26. The openings 218 may be used for a pick and place operation. The openings 218 may be used to hold positions of the busbars 200 during the overmolding process of forming the busbar carrier 110.

In an exemplary embodiment, each busbar 200 is generally rectangular. For example, the busbar 200 includes a first end, a second end, a first side, and a second side. The busbar 200 may be elongated, such as having the ends longer than the sides. In an exemplary embodiment, the busbar is generally planar. For example, the first and second mating pads 214, 216 may be coplanar for attachment to the cell terminals 24, 26. Optionally, the main body may be offset or out of plane relative to the first and second mating pads 214, 216, such as located above or below the plane of the first and second mating pads 214, 216. The busbar 200 may include mounting features, such as mounting tabs, posts, brackets, clips, notches, openings, and the like for mounting the busbar 200 to the busbar carrier 110.

In an exemplary embodiment, the matrix 202 of the busbars 200 include eight rows 204 of the busbars 200 and twenty-five columns 206 of the busbars 200. Greater or fewer busbars 200 may be provided in the rows 204 and/or the columns 206 in alternative embodiments. In an exemplary embodiment, each cell bussing web 150 includes two rows 204 of the busbars 200 and twenty-five columns 206 of the busbars 200. Greater or fewer busbars 200 may be provided in the rows 204 and/or the columns 206 in alternative embodiments. In an exemplary embodiment, the matrix includes four of the cell bussing webs 150 arranged side-by-side to connect to the various columns of the battery cells. Greater or fewer of the cell bussing webs 150 may be provided in alternative embodiments.

The battery cell sensing assembly 300 includes busbar sensing cables 310 having battery management system (BMS) sensor assemblies 350 configured to be coupled to the corresponding busbars 200. For example, each of the BMS sensor assemblies 350 may be associated with each of the corresponding battery cells 20. Signals from the BMS sensor assemblies 350 may be aggregated and communicated remotely, such as to the control module 400. In an exemplary embodiment, the busbar sensing cables 310 include cell sensing flexible circuits 320 including the BMS sensor assemblies 350. The cell sensing flexible circuits 320 may be flat flexible cables or flexible printed circuits. The battery cell sensing assembly 300 may include connecting cables (not shown) coupled to each of the busbar sensing cables 310 to aggregate signals for the battery cell sensing assembly 300. For example, the busbar sensing cables 310 and the connecting cables 312 form a lattice structure that overlaps the matrix 202 of the busbars 200. The connecting cables 312 may be flexible circuits, such as flat flexible cables or flexible printed circuits. In other various embodiments, the connecting cables may be coaxial cables having RF connectors configured to be coupled to the busbar sensing cables 310. The busbar sensing cables 310 and the connecting cables may be oriented perpendicular to each other. The busbar sensing cables 310 may be flexible circuits, such as flat flexible cables or flexible printed circuits. The connecting cables may be flexible circuits, such as flat flexible cables or flexible printed circuits.

In an exemplary embodiment, the cell sensing flexible circuits 320 extend along the rows 204 of the busbars 200 and are electrically connected to each of the busbars 200 in the corresponding rows 204 at the corresponding sensing points 302 to sense characteristics, such as voltage, of each of the corresponding busbars 200. The connecting cables may span each of the cell sensing flexible circuits 320 and are electrically connected to the busbar sensing cables 310 to aggregate the signals from the busbar sensing cables 310. The busbar sensing cables 310 and/or the connecting cables may be electrically connected to the control module 400.

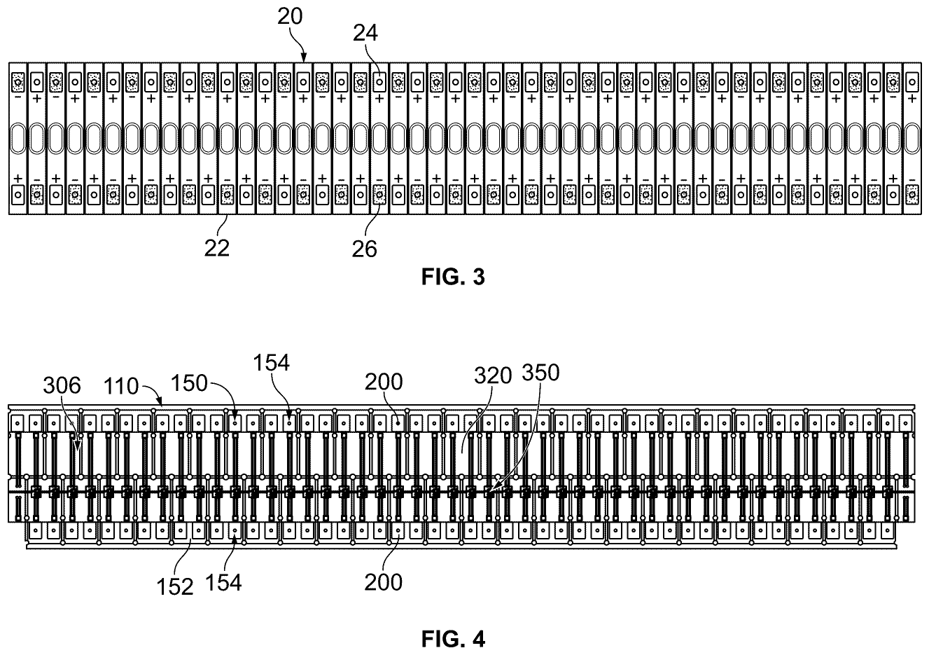

FIG. 3 illustrates a stack of the battery cells 20 and FIG. 4 illustrates a cell bussing web 150 for connecting to the stack of battery cells 20 shown in FIG. 3. Each battery cell 20 includes the cell housing 22, the first cell terminal 24, and the second cell terminal 26. The battery cells 20 are rectangular arranged in a stacked configuration (for example, a cell column). The cell bussing web 150 (FIG. 4) is configured to be coupled to the stack of battery cells 20. Adjacent battery cells 20 are configured to be interconnected by the corresponding busbars 200 of the cell bussing web 150.

In an exemplary embodiment, an insulation film 152 surrounds the busbars 200 of the cell bussing web 150. The cell sensing flexible circuits 320 coupled to the corresponding busbars 200 forming part of the battery cell sensing assembly 300. In various embodiment, the cell sensing flexible circuits 320 are coupled to the busbars 200 by a conductive adhesive film applied to the busbars 200, such as prior to application of the insulation film 152. In other various embodiments, the cell sensing flexible circuits 320 are coupled to the busbars 200 by soldering or welding pads or conductors of the cell sensing flexible circuits 320 to the busbars 200.

The insulation film 152 may form at least part of the busbar carrier 110. For example, the insulation film 152 may hold relative positions of the busbars 200 within the cell bussing web 150. In an exemplary embodiment, the insulation film 152 includes windows 154 exposing portions of the busbars 200, such as portions of the busbars 200 configured to be terminated (for example, welded) to the cell terminals 24, 26 of the battery cells 20. The cell sensing flexible circuits 320 are coupled to the busbars 200 at the exposed portions through the windows 154. The BMS sensor assemblies 350 are electrically connected to the corresponding busbars 200 through the cell sensing flexible circuits 320.

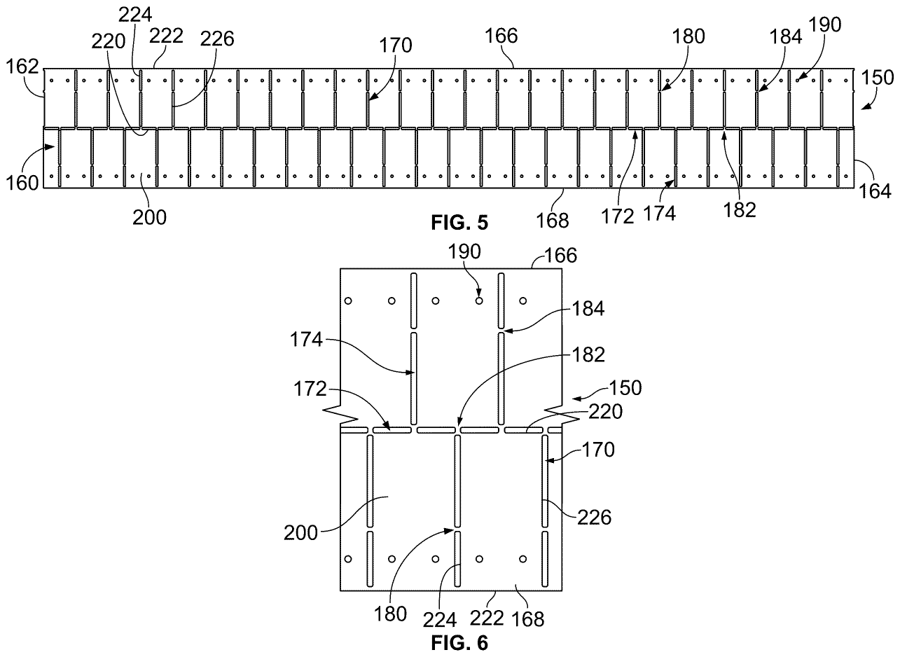

FIG. 5 illustrates the cell bussing web 150 in accordance with an exemplary embodiment. FIG. 6 is an enlarged view of a portion of the cell bussing web 150 shown in FIG. 5. In an exemplary embodiment, the cell bussing web 150 includes a metal sheet 160 that forms the busbars 200. A plurality of the busbars 200 are formed from the metal sheet 160. In an exemplary embodiment, each busbar 200 is generally rectangular. For example, each busbar 200 includes the first end 220, the second end 222, the first side 224, and the second side 226.

In an exemplary embodiment, the metal sheet 160 may be formed from a metal coil or reel that is unwound and processed to form the busbars 200. For example, the metal sheet 160 may be fed from a continuous coil and cut to length corresponding to the length of the stack of the battery cells 20 in the busbars 200 may be individually separated from the metal sheet 160 to electrically connect the corresponding battery cells 20. The metal sheet may be a layered structure formed from multiple layers or sheet of metal that are stacked to form the metal sheet 160. The metal sheet 160 may be made from a metal material, such as copper or aluminum. Aluminum may be used for cost and weight savings compared to copper. In various embodiments, the metal sheet 160 is an aluminum sheet, a copper clad aluminum sheet, a nickel treated aluminum sheet, or other type of aluminum or aluminum alloy sheet.

The metal sheet 160 has a length extending between a first end 162 and a second end 164. The metal sheet 160 has a width extending between a first side 166 and a second side 168. The metal sheet 160 extends longitudinally, lengthwise between the first and second ends 162, 164. The metal sheet 160 extends laterally between the first and second sides 166, 168. In an exemplary embodiment, the metal sheet 160 includes a plurality of the busbars 200 arranged longitudinally between the first and second ends 162, 164. For example, in the illustrated embodiment, the metal sheet 160 includes approximately forty-nine busbars 200 between the first and second ends 162, 164 arranged in two rows. The metal sheet 160 may include greater or fewer busbars 200 in alternative embodiments. In an exemplary embodiment, the metal sheet includes a plurality of the busbars 200 arranged laterally (for example, side to side) between the first and second sides 166, 168. For example, in the illustrated embodiment, the metal sheet 160 includes two rows of the busbars 200 between the first and second sides 166, 168. The busbars 200 at the first side 166 are configured to interface with the cell terminals 24, 26 at first sides of the battery cells 20 and the busbars 200 at the second side 168 are configured to interface with the cell terminals 24, 26 at second sides of the battery cells 20.

In an exemplary embodiment, the metal sheet 160 includes slots 170 through the metal sheet 160. The slots 170 separate the busbars 200 from one another. In an exemplary embodiment, the slots 170 are formed by a cutting process, such as a laser-based cutting process (for example, laser blanking). The slots 170 may be cut in the metal sheet 160 as a metal sheet 160 is unwound from the reel. The slots 170 separate the busbars 200 in the rows from each other and the slots 170 separate the busbars 200 in the columns from each other.

In an exemplary embodiment, the slots 170 include longitudinal slots 172 extending longitudinally along the metal sheet 160, such as parallel to the first and second sides 166, 168. The longitudinal slots 172 are provided between the rows of the busbars 200. In the illustrated embodiment, the longitudinal slots 172 are centered along the metal sheet 160 between the first and second sides 166, 168. As such, the busbars 200 in the two rows have equal widths. However, the longitudinal slots 172 may be offset, such as closer to the first side 166 or closer to the second side 168 such that the busbars 200 have different widths.

In an exemplary embodiment, the slots 170 include lateral slots 174 extending laterally across the metal sheet 160, such as between the first and second sides 166, 168. The lateral slots 174 separate the columns of the busbars 200 from each other. In the illustrated embodiment, the lateral slots 174 on the opposite sides of the longitudinal slots 172 are offset from each other such that the busbars 200 in the adjacent rows are staggered relative to each other. However, in alternative embodiments, the lateral slots 174 on the opposite sides of the longitudinal slots 172 may be aligned with each other such that the busbars 200 in the adjacent rows are aligned with each other.

In an exemplary embodiment, the metal sheet 160 includes sacrificial connecting tabs 180 spanning across the slots 170 between the corresponding adjacent busbars 200 to hold relative positions of the busbars 200. The sacrificial connecting tabs 180 are configured to be removed at a later processing step, such as after the busbars 200 are held together by the busbar carrier 110, to singulate the busbars 200 from each other and thus electrically separate the adjacent busbars 200 from each other. The sacrificial connecting tabs 180 may be removed by a cutting process, such as a laser based cutting process. In an exemplary embodiment, the slots 170 do not extend the entire length of the metal sheet 160 or the entire width of the metal sheet 160. Rather, the slots 170 extend only partially along the length and the width of the metal sheet 160, leaving behind the sacrificial connecting tabs 180 to hold the relative positions of the busbars 200 and provide sufficient structural integrity for the metal sheet 160, such as for further processing and assembly.

In an exemplary embodiment, the sacrificial connecting tabs 180 include longitudinal connecting tabs 182 extending across the longitudinal slots 172. The longitudinal connecting tabs 182 connect the busbars 200 in the opposite rows. The longitudinal connecting tabs 182 may be provided at the corners of the busbars 200, such as at the first side 224 and the second side 226 of each busbar 200. The longitudinal connecting tabs 182 may be provided at a central location along the inner ends 220 of the busbars 200. Other locations are possible in alternative embodiments.

In an exemplary embodiment, the sacrificial connecting tabs 180 include lateral connecting tabs 184 extending across the lateral slots 174. For example, the lateral connecting tabs 184 may extend between the first side 224 of one of the busbars 200 and the second side 226 of the adjacent busbar 200. The lateral connecting tabs 184 connect the adjacent busbars 200 in each of the rows. The lateral connecting tabs 184 may be provided at the corners of the busbars 200, such as at the inner ends 220 and the outer ends 222 of each of the busbars 200. The lateral connecting tabs 184 may be provided at an intermediate location between the ends 220, 222, such as approximately centered between the ends 220, 222.

In an exemplary embodiment, the metal sheet 160 includes openings 186 in each of the busbars 200. Optionally, multiple openings 186 may be provided in each of the busbars 200. The openings 186 may be used for positioning the busbars 200 relative to the cell terminals 24, 26 of the battery cells 20. The openings 186 may be used for terminating to the cell terminals 24, 26, such as by a laser welding process. In the illustrated embodiment, the openings 186 are located proximate to the outer ends 222 of the busbars 200. Other locations are possible in alternative embodiments. The openings 186 may be formed by a laser cutting process (for example, laser blanking).

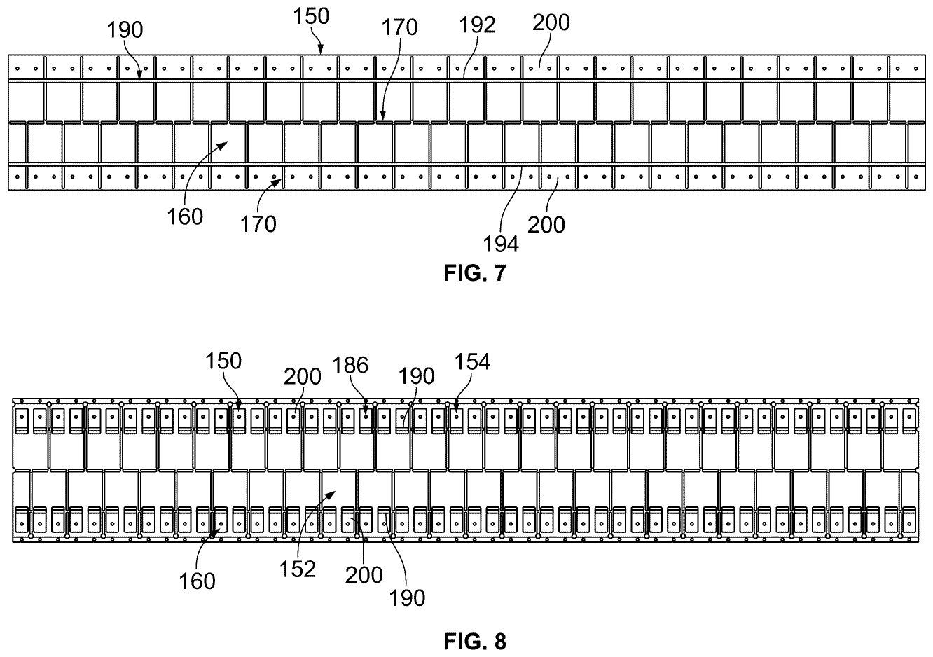

FIG. 7 illustrates the cell bussing web 150 in accordance with an exemplary embodiment showing a conductive adhesive film 190 applied to the metal sheet 160. The conductive adhesive film 190 is mechanically and electrically connected to the corresponding busbars 200. The conductive adhesive film 190 is used to electrically connect the cell sensing flexible circuit 320 to the busbars 200. The conductive adhesive film 190 may be applied as a continuous strip spanning the length of the cell bussing web 150. The conductive adhesive film 190 may be supplied in reel format (e.g. tape) and may be applied to the cell bussing web in a continuous fashion, enabling a seamless inline joining to the cell bussing web. The conductive adhesive film 190 may be tacked in place preliminarily to the busbar web without completely curing the adhesive. For example, the conductive adhesive film 190 may be attached to the metal sheet 160 by application of heat and/or pressure.

In an exemplary embodiment, the cell bussing web 150 may include multiple conductive adhesive films 190, such as two rows of the conductive adhesive films 190 associated with the two rows of the busbars 200. For example, the conductive adhesive film 190 includes a first conductive adhesive strip 192 on a first row of the busbars 200 and a second conductive adhesive strip 194 on a second row of the busbars 200.

In an exemplary embodiment, the conductive adhesive film 190 includes adhesives such as acrylic, epoxy, urethanes, and the like loaded with metallized particles. For example, the conductive adhesive film 190 may be loaded with microscopic conductive particles capable of electrically connecting aluminum or copper busbar and flexible circuit substrates. The conductive particles may be gold particles, silver particles, nickel particles and/or metallized polymer particles. The conductive particles may have a rough or spiky surface on the particles employed to aid in making the electrical connection between the busbars 200 and the cell sensing flexible circuit 320 by breaking any oxide layers that may be present. In various embodiments, the conductive adhesive film 190 may be anisotropic (for example, conductive only in the normal direction and insulative in the in-plane direction), which may prevent short circuiting or electrical connection of adjacent circuits and busbars 200. In other various embodiments, the conductive adhesive film 190 may be isotropic in nature (for example, conductive in all direction after curing) and may be discontinuous to avoid short circuiting or electrical connection of adjacent circuits and busbars 200. For example, the conductive adhesive film 190 may be cut at predetermined locations, such as at the slots 170 between the busbars 200, to isolate the circuits from each other. The conductive adhesive film 190 may be aligned with and cut with the sacrificial connecting tabs 180 during the singulation process when the sacrificial connecting tabs 180 are cut.

FIG. 8 illustrates the cell bussing web 150 in accordance with an exemplary embodiment showing the insulation film 152 surrounding the metal sheet 160. The insulation film 152 is applied to the metal sheet 160. In an exemplary embodiment, the insulation film 152 is applied after the conductive adhesive film 190 is applied to the metal sheet 160. The conductive adhesive film 190 may be used to mechanically connect the insulation film 152 to the metal sheet 160. A non-conductive adhesive film (not shown) may be used to mechanically connect the insulation film 152 to the metal sheet 160.

In various embodiments, the insulation film 152 may be applied by a lamination process to cover the top surface and/or the bottom surface of the metal sheet 160. The insulation film 152 may be applied as a continuous strip spanning the length of the cell bussing web 150. The insulation film 152 may be supplied in reel format (e.g. tape) and may be applied to the cell bussing web 150 in a continuous fashion, enabling a seamless inline joining to the cell bussing web 150. When applied, the insulation film 152 covers the sacrificial connecting tabs 180. The insulation film 152 spans the slots 170 and may support the busbars 200 relative to each other.

The insulation film 152 includes the windows 154 that expose portions of the metal sheet 160. In the illustrated embodiment, the windows 154 are aligned with the openings 186. The windows 154 expose portions of the busbars 200 for termination cell terminals 24, 26 of the battery cells 20, such as for laser welding the busbars 200 to the cell terminals 24, 26. The conductive adhesive film 190 may be exposed in the windows 154, such as for connection of the cell sensing flexible circuits 320 to the busbars 200.

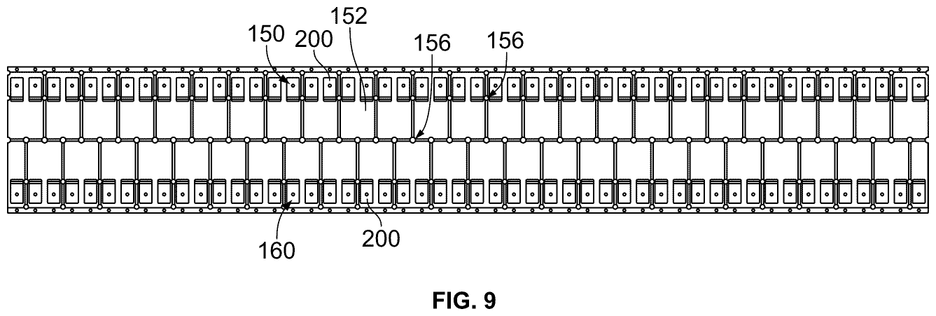

FIG. 9 illustrates the cell bussing web 150 in accordance with an exemplary embodiment showing the insulation film 152 and the metal sheet 160 after removal of the sacrificial connecting tabs 180. During manufacture, the sacrificial connecting tabs 180 are removed to singulate the busbars 200 from each other and thus electrically separate the adjacent busbars 200 from each other. The sacrificial connecting tabs 180 may be removed by a cutting process, such as a laser based cutting process. During the removal process, portions of the insulation film 152 are also removed. For example, the insulation film 152 may include openings 156 at the areas where the sacrificial connecting tabs 180 are removed. However, other portions of the insulation film 152 remain spanning across the slots 170 thus holding relative positions of the busbars 200 even after the sacrificial connecting tabs 180 are removed.

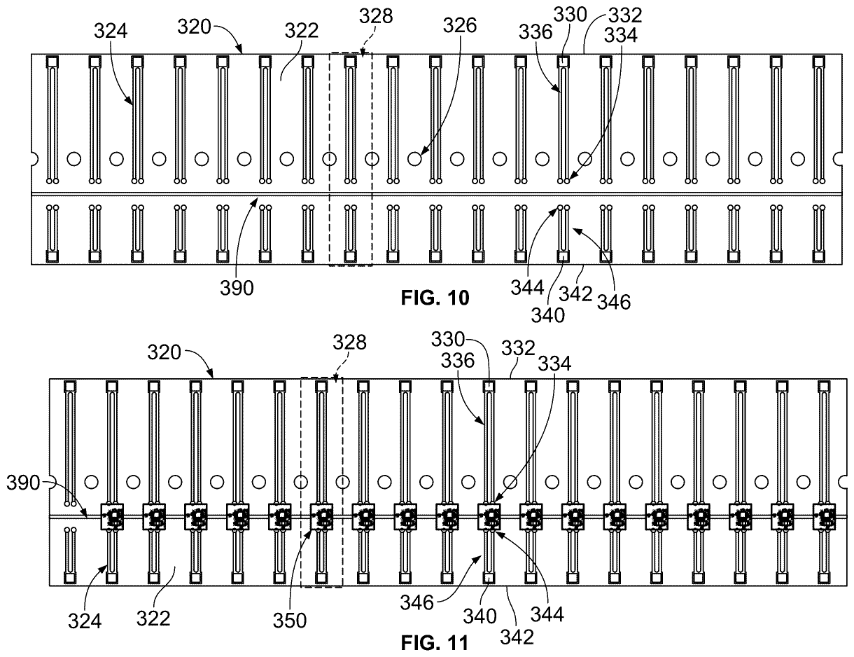

FIG. 10 illustrates the cell sensing flexible circuit 320 in accordance with an exemplary embodiment. FIG. 11 illustrates the cell sensing flexible circuit 320 with the BMS sensor assemblies 350 coupled to the cell sensing flexible circuit 320. The cell sensing flexible circuit 320 includes a substrate 322 and circuits 324 on one or more layers of the substrate 322. The substrate 322 may be a flat flexible cable or flexible printed circuit. In an exemplary embodiment, the substrate 322 includes openings 326. The openings 326 may be used for pick and place of the cell sensing flexible circuit 320. The openings 326 may be used for aligning with the battery cells 20.

In an exemplary embodiment, the cell sensing flexible circuit 320 includes a repeating trace pattern 328 along a length of the cell sensing flexible circuit 320. The trace pattern 328 includes a first cell pad 330 at a first side 332 of the cell sensing flexible circuit 320 and a second cell pad 340 at a second side 342 of the cell sensing flexible circuit 320. The first cell pad 330 is configured for connection to the first cell terminal 24 of the battery cell 20 and the second cell pad 340 is configured for connection to the second cell terminal 26 of the battery cell 20. The trace pattern 328 includes a first sensor pad 334 coupled to the first cell pad 330 by a first conductor 336 and a second sensor pad 344 coupled to the second cell pad 340 by a second conductor 346. The BMS sensor assemblies 350 are coupled to the cell sensing flexible circuit 320 at the first and second sensor pads 334, 344. In an exemplary embodiment, the first and second conductors 336, 346 are strip line conductors each having a pair of traces between the cell pads 330, 340 and the sensor pads 334, 344. In an exemplary embodiment, the trace patterns 328 are provided on the top surface of the substrate 322. However, the trace patterns 328 may be on other layers and may be connected between the layers by vias.

In an exemplary embodiment, the cell sensing flexible circuit 320 includes a bus antenna 390 extending lengthwise along the cell sensing flexible circuit 320. The bus antenna 390 traverses the repeating trace patterns 328. The bus antenna 390 is configured to be operably coupled to the BMS sensor assemblies 350, such as to receive sensor signals from the BMS sensor assemblies 350 and communicate the sensor signals remotely, such as to control module 400. In the illustrated embodiment, the bus antenna 390 is located between the first and second sensor pads 334, 344. The BMS sensor assemblies 350 extend over the bus antenna 390. In various embodiments, the bus antenna 390 is a strip line antenna having a pair of conductors.

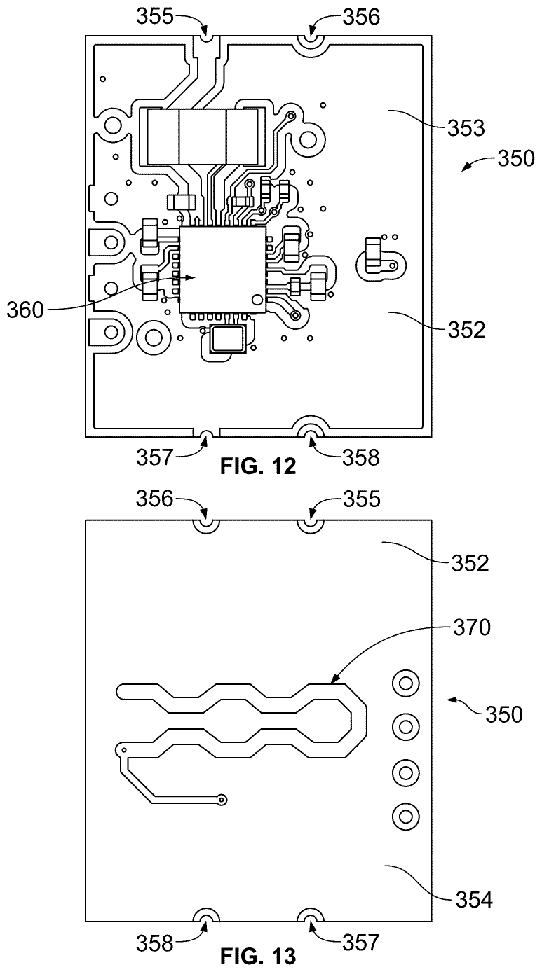

FIG. 12 is a top view of the BMS sensor assembly 350 in accordance with an exemplary embodiment. FIG. 13 is a bottom view of the BMS sensor assembly 350 in accordance with an exemplary embodiment. The BMS sensor assembly 350 includes a sensor printed circuit board (PCB) 352, an integrated circuit 360 mounted to the sensor PCB 352, and a sensor antenna 370 operably coupled to the integrated circuit 360. Other components may be coupled to the sensor PCB 352. The integrated circuit 360 may include or define a processor for processing signals, such as for monitoring at least one operating characteristic of the battery cell 20, such as voltage, temperature, operational status, and the like.

The sensor PCB 352 includes an upper surface 353 and a lower surface 354. The integrated circuit 360 is coupled to the upper surface 353. In the illustrated embodiment, the sensor antenna 370 is provided at the lower surface 354. In an exemplary embodiment, the sensor PCB 352 includes a power input 355, a ground input 356, a positive voltage input 357, and a negative voltage input 358. The power input 355 and the positive voltage input 357 may be connected to the first sensor pad 334 at a first side of the sensor PCB 352. The ground input 356 and the negative voltage input 358 may be connected to the second sensor pad 344 at a second side of the sensor PCB 352. The sensor PCB 352 is coupled to the first and second sensor pads 334, 344 to receive signals from the first and second cell terminals 24, 26 of the corresponding battery cell 20. The integrated circuit 360 is operably coupled to the battery cell 20 through the sensor PCB 352.

The sensor antenna 370 is configured to transmit a sensor signal from the BMS sensor assembly 350 relating to the at least one operating characteristic. The sensor antenna 370 is configured to be coupled with the bus antenna 390. For example, the sensor antenna 370 may face the bus antenna 390. The sensor antenna 370 may be coupled to the bus antenna 390 either directly, such as being soldered to the bus antenna 390, or indirectly, such as being capacitively coupled with the bus antenna 390.

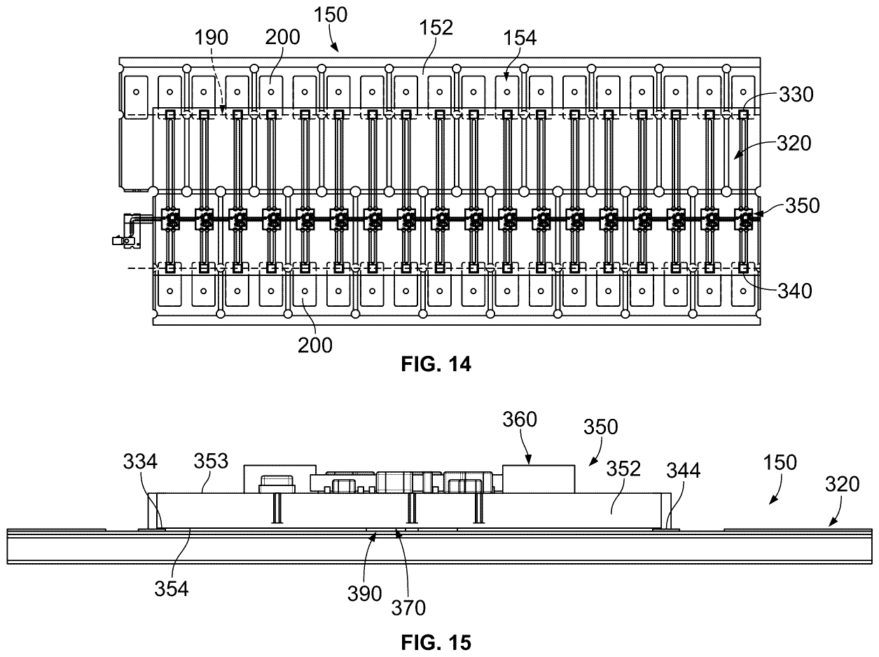

FIG. 14 illustrates the cell bussing web 150 in accordance with an exemplary embodiment showing the cell sensing flexible circuit 320 coupled to the insulation film 152 and the busbars 200. The cell sensing flexible circuit 320 includes the BMS sensor assemblies 350. Each BMS sensor assembly 350 is configured to be electrically connected to the corresponding busbar 200. For example, the BMS sensor assembly 350 may be aligned with the window 154 and coupled to the conductive adhesive film 190.

In an exemplary embodiment, the cell sensing flexible circuit 320 is applied as a continuous strip spanning the length of the cell bussing web 150. During manufacture, the cell sensing flexible circuit 320 is applied to the cell bussing web 150 by laying the cell sensing flexible circuit 320 over the insulation film 152. The first and second cell pads 330, 340 of the cell sensing flexible circuit 320 are coupled to the corresponding busbars 200. For example, the first and second cell pads 330, 340 of the cell sensing flexible circuit 320 are coupled to the busbars 200 using the conductive adhesive film 190, such as by pressing the cell sensing flexible circuit 320 inward (for example, downward) and applying pressure to connect the cell sensing flexible circuit 320 to the conductive adhesive film 190. Heat may be applied to cure the conductive adhesive film 190. In other embodiments, the first and second cell pads 330, 340 of the cell sensing flexible circuit 320 is coupled to the busbars 200 by welding, such as ultrasonic welding.

The conductive adhesive film 190 may be supplied in reel format (e.g. tape) and may be applied to the cell bussing web 150 in a continuous fashion, enabling a seamless inline joining to the cell bussing web 150. The conductive adhesive film 190 may be attached to the cell bussing web 150 by application of heat and/or pressure.

In the illustrated embodiment, a single cell sensing flexible circuit 320 is provided covering both rows of the busbars 200 and being electrically connected to the busbars 200 in both rows. In alternative embodiments, multiple cell sensing flexible circuits 320 are provided, each coupled to a different conductive adhesive film 190 and a different row of the busbars 200. Each BMS sensor assembly 350 is coupled to the corresponding busbars 200. For example, each BMS sensor assembly 350 is configured to be operably coupled to a monitor a different battery cell 20 of the battery pack 10.

FIG. 15 is a cross-sectional view of the cell bussing web 150 showing the cell sensing flexible circuit 320 and the BMS sensor assembly 350 coupled to the cell bussing web 150. When assembled, the integrated circuit 360 is coupled to the upper surface 353 of the sensor PCB 352. The integrated circuit 360 is operably coupled to the battery cell 20 through the sensor PCB 352. The sensor antenna 370 is provided at the lower surface 354 and faces the bus antenna 390 of the cell sensing flexible circuit 320. The sensor PCB 352 is coupled to the cell sensing flexible circuit 320 at the first and second sensor pads 334, 344. The sensor PCB 352 is coupled to the first and second sensor pads 334, 344 to receive signals from the first and second cell terminals 24, 26 of the corresponding battery cell 20.

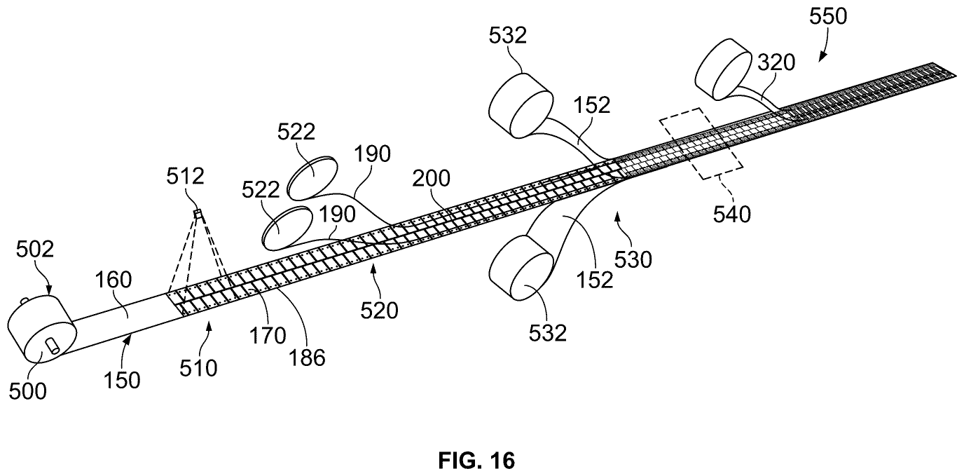

FIG. 16 illustrates a manufacture process for the cell bussing web 150 in accordance with an exemplary embodiment. The metal sheet 160 is initially arranged as a metal coil 500 on a reel 502. The metal sheet 160 is unwound from the reel 502 and may be continuously pulled through one or more processing stations. In an exemplary embodiment, the metal sheet 160 on the reel 502 has a width corresponding to the desired width of the cell bussing web 150, such as a width corresponding to the width of the battery cell 20.

In an exemplary embodiment, the metal sheet 160 is moved through a blanking station 510 where the slots 170 and the openings 186 are formed in the metal sheet 160. In an exemplary embodiment, one or more lasers 512 may be provided at the blanking station 510 for cutting these slots 170 and the openings 186 in the metal sheet 160. The lasers 512 may be configured to cut the slots 170 as the metal sheet 160 is continuously moved through the blanking station 510. In other embodiments, a predetermined length of the metal sheet 160 may be advanced to the blanking station 510 for processing. The metal sheet 160 may remain stationary during the processing at the blanking station 510 before advancing downstream and bringing a new portion of the metal sheet 160 to the blanking station 510.

In an exemplary embodiment, the metal sheet 160 is moved through an adhesive application station 520 where the conductive adhesive film 190 is applied to the metal sheet 160. In an exemplary embodiment, the continuous cell bussing web 150 may be moved through the adhesive application station 520. However, in alternative embodiments, the cell bussing web 150 may be cut to length, such as a length corresponding to the length of the stack of battery cells 20 to provide the metal sheet 160 cut to length. The individual metal sheets 160 may be fed to the adhesive application station 520 rather than being fed as part of the continuous cell bussing web 150. The conductive adhesive film 190 may be initially arranged on a reel 522, such as a film or tape wound on the reel 522. The conductive adhesive film 190 is unwound from the reel 522 and may be continuously applied to the metal sheet 160. Multiple conductive adhesive films 190 may be arranged on different reels 522 and applied to different portions of the metal sheet 160.

In an exemplary embodiment, the metal sheet 160 is moved through a lamination station 530 where the insulation film 152 is applied to the metal sheet 160. The insulation film 152 may be coupled to the conductive adhesive film 190. In an exemplary embodiment, the continuous cell bussing web 150 may be moved through the lamination station 530. However, in alternative embodiments, the cell bussing web 150 may be cut to length, such as a length corresponding to the length of the stack of battery cells 20 to provide the metal sheet 160 cut to length. The individual metal sheets 160 may be fed to the lamination station 530 rather than being fed as part of the continuous cell bussing web 150.

In an exemplary embodiment, the metal sheet 160 is moved through a cutting station 540 where the sacrificial connecting tabs 180 are removed. The cutting station 540 may include one or more lasers for cutting the metal sheet 160 and removing the sacrificial connecting tabs 180. Other types of cutting processes may be performed at the cutting station 540 to remove the sacrificial connecting tabs 180.

In an exemplary embodiment, the metal sheet 160 is moved through a flexible circuit application station 550 where the cell sensing flexible circuit 320 is applied to the cell bussing web 150. The cell sensing flexible circuit 320, with the BMS sensor assemblies 350, may be coupled to the conductive adhesive film 190. The conductive adhesive film 190 is used to electrically connect the cell sensing flexible circuit 320 to the busbars 200. In an exemplary embodiment, the continuous cell bussing web 150 may be moved through the flexible circuit application station 550. However, in alternative embodiments, the cell bussing web 150 may be cut to length, such as a length corresponding to the length of the stack of battery cells 20 to provide the metal sheet 160 cut to length. The individual metal sheets 160 may be fed to the flexible circuit application station 550 rather than being fed as part of the continuous cell bussing web 150.

The cell bussing web 150 may be advanced through other processing stations located upstream or downstream of any of the stations illustrated in FIG. 13.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A battery cell sensing assembly for monitoring cell terminals of battery cells in a battery pack, the battery cell sensing assembly comprising:
a cell sensing flexible circuit having a repeating trace pattern along a length of the cell sensing flexible circuit, the trace pattern including a first cell pad for connection to a first cell terminal of the battery cell and a second cell pad for connection to a second cell terminal of the battery cell, the trace pattern including a first sensor pad coupled to the first cell pad by a first conductor and a second sensor pad coupled to the second cell pad by a second conductor;
battery management system (BMS) sensor assemblies coupled to the cell sensing flexible circuit, each BMS sensor assembly coupled to the corresponding trace pattern, the BMS sensor assembly including a sensor printed circuit board (PCB), an integrated circuit mounted to the sensor PCB, and a sensor antenna operably coupled to the integrated circuit, the sensor PCB coupled to the first and second sensor pads to receive signals from the first and second cell terminals, the integrated circuit operably coupled to the battery cell through the sensor PCB, the integrated circuit monitoring at least one operating characteristic of the battery cell, the sensor antenna configured to transmit a sensor signal from the BMS sensor assembly relating to the at least one operating characteristic;
wherein each BMS sensor assembly is configured to be operably coupled to and monitor a different battery cell of the battery pack.

2. The battery cell sensing assembly of claim 1, wherein the first and second cell pads are located at opposite sides of the cell sensing flexible circuit, the first and second sensor pads being located between the first and second cell pads.

3. The battery cell sensing assembly of claim 1, wherein the cell sensing flexible circuit includes a bus antenna extending lengthwise along the cell sensing flexible circuit and traversing the repeating trace patterns, the bus antenna being operably coupled to the sensor antennas of the BMS sensor assemblies.

4. The battery cell sensing assembly of claim 3, wherein the bus antenna is located between the first and second sensor pads, the BMS sensor assemblies extending over the bus antenna.

5. The battery cell sensing assembly of claim 3, wherein the sensor antenna is located at a bottom of the sensor PCB, the sensor antenna facing the bus antenna.

6. The battery cell sensing assembly of claim 3, wherein the bus antenna is a strip line antenna having a pair of conductors.

7. The battery cell sensing assembly of claim 3, wherein an end of the bus antenna is operably coupled to an RF antenna connector.

8. The battery cell sensing assembly of claim 7, further comprising a balun circuit between the bus antenna and the RF antenna connector.

9. The battery cell sensing assembly of claim 1, wherein the sensor PCB includes a power input, a ground input, a positive voltage input, and a negative voltage input, the power input and the positive voltage input being connected to the first conductor at a first side of the sensor PCB, the ground input and the negative voltage input being connected to the second conductor at a second side of the sensor PCB.

10. The battery cell sensing assembly of claim 1, wherein the cell sensing flexible circuit includes openings for aligning the cell sensor flexible circuit relative to the busbars.

11. The battery cell sensing assembly of claim 1, wherein the first and second conductors have lengths between the first and second cell pads and the first and second sensor pads less than a length of the battery cell.

12. The battery cell sensing assembly of claim 1, wherein the first conductor is a strip line conductor having a pair of traces and the second conductor is a strip line conductor having a pair of traces.

13. A busbar interconnect for electrically connecting cell terminals of battery cells in a battery pack, the busbar interconnect comprising:
a cell bussing web extending between a first side and a second side, the cell bussing web including a plurality of busbars arranged in a matrix having one or more rows of the busbars and one or more columns of the busbars, each busbar includes a first mating end for mating with the corresponding cell terminal of the corresponding battery cell and a second mating end for mating with the adjacent cell terminal of the adjacent corresponding battery cell, the busbars configured to electrically connect the battery cells in the battery pack;
an insulation film covering the busbars, the insulation film including windows exposing portions of the busbars;
a battery cell sensing assembly coupled to the cell bussing web, the battery cell sensing assembly including a cell sensing flexible circuit and battery management system (BMS) sensor assemblies coupled to the cell sensing flexible circuit, the cell sensing flexible circuit having a repeating trace pattern along a length of the cell sensing flexible circuit, the trace pattern including a first cell pad for connection to a first busbar of the plurality of busbars at the first side of the cell bussing web and a second cell pad for connection to a second busbar of the plurality of busbars at the second side of the cell bussing web, the trace pattern including a first sensor pad coupled to the first cell pad by a first conductor and a second sensor pad coupled to the second cell pad by a second conductor, each BMS sensor assembly coupled to the corresponding trace pattern, the BMS sensor assembly including a sensor printed circuit board (PCB), an integrated circuit mounted to the sensor PCB, and a sensor antenna operably coupled to the integrated circuit, the sensor PCB coupled to the first and second sensor pads to receive signals from the first and second cell terminals, the integrated circuit operably coupled to the battery cell through the sensor PCB, the integrated circuit monitoring at least one operating characteristic of the battery cell, the sensor antenna configured to transmit a sensor signal from the BMS sensor assembly relating to the at least one operating characteristic, wherein each BMS sensor assembly is configured to be operably coupled to and monitor a different battery cell of the battery pack

14. The busbar interconnect of claim 13, wherein the cell bussing web includes a metal sheet extending between the first side and the second side, the metal sheet including slots forming the adjacent busbars in the metal sheet, the metal sheet including sacrificial connecting tabs spanning across the slots between the corresponding adjacent busbars to hold relative positions of the busbars in the matrix, the sacrificial connecting tabs configured to be removed to singulate the busbars and electrically separate the adjacent busbars from each other, the insulation film covering the metal sheet.

15. The busbar interconnect of claim 14, further comprising a conductive adhesive film applied to the metal sheet, the conductive adhesive film being mechanically and electrically connected to the corresponding busbars, the first and second cell pads being electrically connected to the corresponding busbars by the conductive adhesive film.

16. The busbar interconnect of claim 14, wherein the metal sheet is cut to length corresponding to a length of the battery pack and the cell sensing flexible circuit is cut to length corresponding to the length of the battery pack.

17. The busbar interconnect of claim 13, wherein the first and second cell pads are located at opposite sides of the cell sensing flexible circuit, the first and second sensor pads being located between the first and second cell pads.

18. The busbar interconnect of claim 13, wherein the cell sensing flexible circuit includes a bus antenna extending lengthwise along the cell sensing flexible circuit and traversing the repeating trace patterns, the bus antenna being operably coupled to the sensor antennas of the BMS sensor assemblies.

19. The busbar interconnect of claim 18, wherein the bus antenna is located between the first and second sensor pads, the BMS sensor assemblies extending over the bus antenna.

20. The busbar interconnect of claim 13, wherein the sensor PCB includes a power input, a ground input, a positive voltage input, and a negative voltage input, the power input and the positive voltage input being connected to the first conductor at a first side of the sensor PCB, the ground input and the negative voltage input being connected to the second conductor at a second side of the sensor PCB.
